(19) United States
(12) Patent Application Publication
(10) Pub. No.: US 2011/0209046 A1
(43) Pub. Date: Aug. 25, 2011

(54) OPTIMIZING WEB CONTENT DISPLAY ON AN ELECTRONIC MOBILE READER

(76) Inventors: Zheng Huang, Redwood City, CA (US); Lei Chen, Shanghai (CN)

(21) Appl. No.: 13/025,107

(22) Filed: Feb. 10, 2011

Related U.S. Application Data
(60) Provisional application No. 61/337,729, filed on Feb. 11, 2010.

(51) Int. Cl. G06F 17/00

(52) U.S. Cl. 715/234

(57) ABSTRACT

The invention provides displaying a web page on a mobile device by decomposing a web page into a plurality of page units; applying a filter to at least one page unit to produce a subset of page units; assembling the subset of page units into an assembled page; and displaying an assembled page. Apparatus, methods and systems therefore are described.

The present application claims the benefit of Provisional Patent Application No. 61/337,729 entitled “Optimizing Web Content Display On An Electronic Book Reader,” filed on Feb. 11, 2010, which is hereby incorporated by reference in its entirety.

### FIELD OF THE INVENTION

The present invention relates to Internet browsing technologies, and more particularly, Internet browsing technologies on electronic mobile readers, or e-readers.

### BACKGROUND OF THE INVENTION

In recent years, technologies such as E-Ink®, made by the E-Ink Corporation of Cambridge, Mass., have enabled mobile devices to closely simulate the experience of reading a real book. As a result, electronic mobile readers, or e-readers, have become very popular. For example, the first offering of the Kindle® e-reader made by Amazon Inc. of Seattle, Wash., was sold out in five and a half hours.

However, currently, e-readers are limited in their functionality, especially displaying web pages. For example, animated Flash® content and images have very poor visual effects on dedicated reading device screens, such as E-Ink® based devices. Further, complex web pages are difficult to display on an e-reader screen with low resolution. Moreover, banner ads, navigation bars, and text boxes are very often irrelevant to a user's reading experience on an e-reader.

Some web sites have offered a mobile version of their content. For an example, cnn.com has made its mobile version available at m.cnn.com. The mobile version is normally simpler and text-centric, compared to its corresponding version on a computer intended for regular use at a single location. However, only a small number of web sites have mobile editions. Even for those web sites that provide mobile editions, the entire web site is not available.

As a result, today's e-readers do not support internet browsing effectively. For example, the nook™ e-reader made by Barnes and Noble, Inc. of New York, N.Y., and the Reader™ e-reader made by the Sony Corporation of Tokyo, Japan, simply do not have web browsing capabilities. Amazon's Kindle® e-reader has a mobile web browser, but it fails to display most complex websites (e.g., yahoo.com) in a user friendly manner.

### OBJECTS AND SUMMARY OF THE INVENTION

It is, therefore, an object of the present invention to optimize web content for display on a mobile device, particularly on an electronic mobile reader (“e-reader”).

Broadly, the present invention is directed to a method and apparatus for receiving web content and converting it into a format that can be displayed on a mobile e-reader. One aspect of the invention is directed to a method for processing a web page comprising the steps of:
1. Page decomposition in which an original web page is decomposed into page units;
2. Filter selection in which the types of pages units to be displayed in an assembled web page are determined;
3. Page unit filtering in which a subset of page units are generated; and
4. Page unit assembling in which the subset of page units are assembled into an assembled page.

Advantageously, the subset of page units correspond to the page units to be displayed according to a predetermined specification, as will be described more fully below.

Another aspect of the invention is directed to a mobile device capable of displaying an assembled page comprising a decomposer for decomposing a web page into a plurality of page units; a filter for filtering at least one page unit and producing thereby a subset of the plurality of page units; an assembler for assembling the subset of page units; and a display for displaying the assembled subset of page units as an assembled page. One such apparatus is an e-reader having a computing system architecture as would be understood by a person having ordinary skill in the art.

Yet another embodiment of the invention is directed to a system that includes a mobile device and a web site and a communications link therebetween. In such a system, the computers that are part of the system, and/or the mobile device can include devices, programs, connections, functions, and functionality such as, but not limited to, a display, a central processing unit, random access memory, read only memory, a bus controller, an interrupt controller, mass storage, removable media, fixed disk drive, keyboard, mouse, audio and/or video transducer, audio and/or video controller, network adapter, web server, local area network, wide area network, process scheduling, memory management, networking, I/O services, communications adapter, interface device, and a connection to a network over a medium (such as a tangible medium, including but not limited to optical or hard-wire communications lines, or a wireless medium, including but not limited to microwave, infrared, or other transmission techniques).

In one embodiment, an original web page is decomposed into page units. One or more filters are then applied to the page units. The subset of page units that are not removed by the selected filter(s) are then assembled into an assembled page that is displayed on a device.

The present invention also is particularly useful for devices that have a limited ability to display all elements of a web page, such as those found in e-readers and mobile tablets which do not display moving images well.

In the specification, the singular forms include plural references unless the context clearly dictates otherwise. Unless defined otherwise all technical and scientific terms used herein have the same meaning as commonly understood by one of ordinary skill in the art to which this invention belongs.

### BRIEF DESCRIPTION OF THE FIGURES

Other features, objects, and advantages of the present invention will be apparent to a person of ordinary skill in the art from the following detailed description made with reference to the drawings annexed in which:

FIG. 1 is a flow chart that illustrates certain features of a method for optimizing web content display, according to an embodiment of the present invention;

FIG. 2 is a flow chart that illustrates certain features of a method for optimizing web content display, according to an embodiment of the present invention;

FIG. 3 depicts an algorithm that can be used in a device-based filter, according to an embodiment of the present invention;

FIG. 4 depicts an algorithm that can be used in a content-based filter, according to an embodiment of the present invention;

FIG. 5 depicts sub-algorithms that can be used in a content-based filter, according to an embodiment of the present invention;

FIG. 6 illustrates a comparison of a web page to an embodiment of the present invention;

FIG. 7 illustrates a comparison of a web page to an embodiment of the present invention;

FIG. 8 is a flow chart that illustrates certain features of a method for optimizing web content display, according to an embodiment of the present invention; and

FIG. 9 is a flow chart that illustrates certain features of a method for optimizing web content display, according to an embodiment of the present invention.

### DETAILED DESCRIPTION OF THE INVENTION

The present invention is directed to optimizing web content for display on a mobile device such as an e-reader. Although the following description describes an embodiment for use with an e-reader, it should be understood that this invention is applicable to and can be used with any mobile or handheld device.

As used herein, a “page unit” is a fragment of the information of a web page as normally displayed in a browser. A web page can be decomposed into the smaller page units, such as, but not limited to, text units, picture units, hyperlink units, and multimedia units. These page units can be processed later and stored separately. As non-limiting examples, a page unit can be the result of a web search, image search, or a news search. Advantageously, page units that the manufacturer and/or the user consider to be irrelevant or “spam” can be filtered and/or discarded.

In one preferred embodiment of the present invention, a web page is decomposed into page units. A filter is then applied to the page units and page units identified as unwanted are filtered out. The remaining subset of page units can then be assembled to create an assembled page. This assembled page may be cleaner and/or smaller than the original web page.

### Decomposition

Decomposition in accordance with the present invention concerns processing an original web page by decomposing it into page units. The content and visual information of each page unit is then collected. In one embodiment, a web page is written in Hyper Text Markup Language (“HTML”). Page units for such a web page include, but are not limited to, a link, a text label, a table, and an image. Each page unit optionally can be tagged with geographic information, which indicates the location of that page unit in the original web page as displayed in a browser.

A given page unit can also contain other smaller page units. For example, a table unit might contain multiple table row units. An original web page then can be decomposed into page units by applying HTML rendering or layout engines (such as WebKit or Gecko) to the original web page. An original web page can also be decomposed into page units by parsing the HTML text using XML/DOM into a Document Object Module (“DOM”) such that the objects can be manipulated by an application program.

### Filter Selection

Filters can be selected by a person of ordinary skill in the art as a matter of design choice according to device specifications, user preferences and/or characteristics of the page units. The device specifications can identify the types of page units to be displayed in an assembled page. For example, dynamic content, such as Flash® or video, cannot be displayed properly on screens using the existing technology, such as E Ink® based devices. Thus, in one preferred embodiment, filters can be selected to identify page units containing such dynamic content.

A user preference can also identify the types of page units to be displayed in an assembled page. For example, a user might not want to display navigation ads on an e-reader. Thus, a setup option can be provided that the user can actuate and select what types of page units will be displayed for a given set of circumstances. This setup option results in a specification to be applied to the web page.

Generally, every web page can present information differently. The original web page can be a factor in determining the types of page units to assemble. For example, merchandise or commercial information may not be filtered on an e-commerce-related web page, while it may be filtered on a web page for news. Thus, a specification can be set to classify an original web page based on the category of content extracted from the original web page and/or the page units. The accuracy of the information extracted can be greatly increased if the type of web site is known in advance.

### Filter

The page units can be filtered based on an application of the selected filter or filters. Not all the page units can be or should be displayed on the client device. Animated Flash® and images have very poor visual effects on screens using the existing technology, such as E Ink®. Preferably, during this step, selected filters are applied to remove page units that are identified as page units that should not be displayed according to the criteria defined by the device or the user of the device, as the case may be.

Various filters can be used in accordance with the present invention. In one embodiment, a device-based filter, which is triggered by a specification of the reading device, is applied.

In another embodiment, a content-based filter, which is based on the properties of the original web page and/or page units, is applied. A content-based filter can be applied based on the classification result of the original page and/or page units. As a non-limiting example, a page unit that contains merchandise information from a web page classified as “e-commerce” may not be filtered out, while a page unit that contains advertisement information from a web page classified as “news” can be filtered out. As another non-limiting example, the footer and header information (according to the geographic information) can be filtered, i.e., removed, as they do not provide much reading value.

For each filter, the input and the output are both page units.

### Assembly

After a filter is applied to the page units, the remaining subset of page units are assembled. These page units preferably can be assembled in accordance with the specification of the target reading device and/or end user preferences. In one embodiment, the geographic information of the page units is altered to achieve maximal readability in the device. In this regard, the device can map the original web content geographic information to the mobile device display geographic information, considering the relative positioning of the page unit in the original web page and in the assembled web page for display on the mobile device. In other words, the geographic information is used to assemble the subset of page units to present the content of the subset of page units in a meaningful way to the reader.

In an alternate embodiment, the content information and the geographic properties of the subset of page units from the original web page are used to assemble the layout of the subset of page units.

In another embodiment, the subset of page units can be converted into semantic data files with all the geographic location information removed. The semantic information is then used to assemble the layout based on the semantic information of the subset of page units. In one embodiment, the semantic information is encoded in Extensible Markup Language format.

### Example 1

### Page Decomposition Process

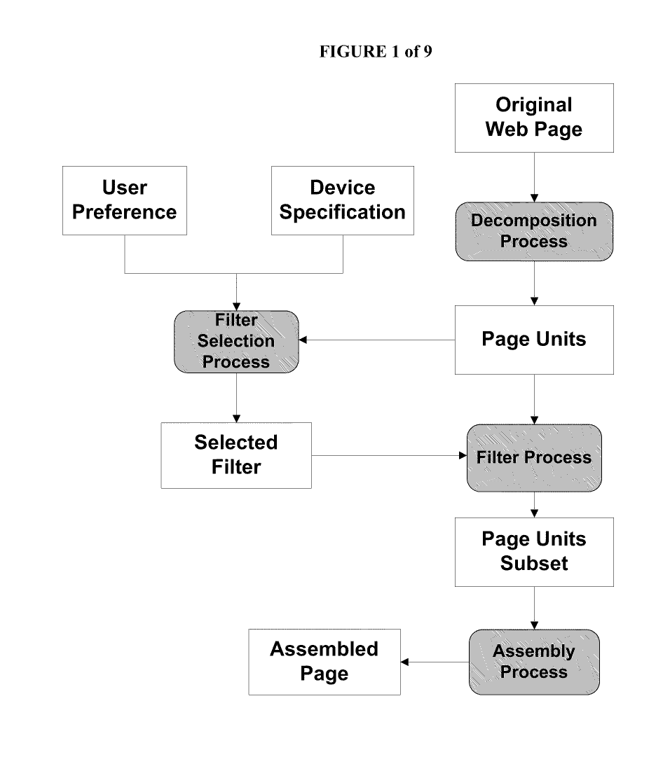

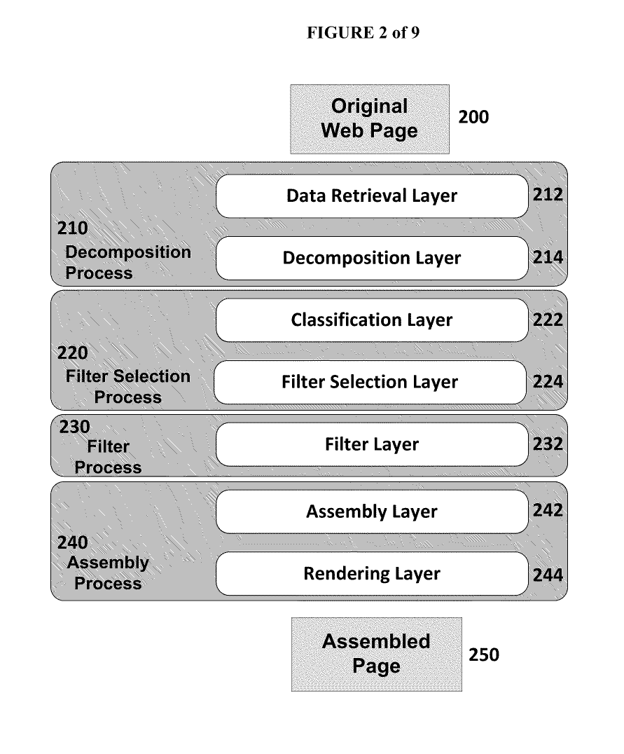

In accordance with a preferred embodiment of the present invention, a page decomposition process will now be described with reference to FIGS. 1 and 2. This process includes:
Function: Decompose the original web page into page units.
Input: URL for the original web page.
Output: Page units which can be assessed and evaluated via the API of an HTML render engine.

As illustrated in FIG. 2, the Page Decomposition Process 210 of the invention includes the Data Retrieval Layer 212 and the Decomposition Layer 214. For each Original Web Page 200, three open source HTML rendering engines were used running on different servers in parallel. The Data Retrieval Layer 212 downloaded the HTML and JavaScript files of the Original Web Page 200 from the source web site and stored the Original Web Page in a distributed file system, which was shared by the three engines. The Decomposition Layer 214 of the rendering engines decomposed the Original Web Page 200 and output page units.

Three types of open source HTML rendering engines (Gecko, WebKit, and Lynx) were deployed within a server farm. The server farm consisted of eight servers. Each server hosted ten instances of each rendering engine and each rendering engine could handle one request at a time.

When a request was received, the input URL was first sent to three engine instances simultaneously and the engines fetched the page content and transferred the downloaded page into DOM data structure. The rendered results were then aggregated to produce the final DOM, which was used to generate the assembled page content.

### Example 2

### Filter Selection Process

In accordance with a preferred embodiment of the present invention, a filter selection process will now be described with reference to FIGS. 1 and 2. This process includes:
Function: Select filters to be used.
Input: Page units, the device specification, and the user preferences.
Output: Set of filters.

The Filter Selection Process 220 includes the Classification Layer 222 and the Filter Selection Layer 224. The Classification Layer 222 classifies the Original Web Page 200 and/or the page units. This classification contributes to deciding which filters to use to generate the subset of page units. To classify the Original Web Page 200, the features of the page units were extracted. Each feature is a numeric or string value. For example, the title of a page is a feature which was extracted from the text field of the title unit. The number of images is a feature that was computed by summing the number of all the image units on the Original Web Page 200. The classification of the Original Web Page 200 was determined by computing the statistics about the features and by applying classifiers such as a naive Bayesian classifier. In this example, the Original Web Page 200 was classified into multiple categories such as news, blog, or discussion forum. Each classification was associated with a set of specific filters.

The Filter Selection Layer 224 takes the classification of the page, the device specification, and the user preferences into consideration to generate a series of filters to be used in the Filter Process 230.

### Example 3

### Filter Process

In accordance with a preferred embodiment of the present invention, a filter process will now be described with reference to FIGS. 1-5. This process includes:
Function: Generate a subset of page units.
Input: Page units and the classification label of the original web page.
Output: Subset of page units.

The Filter Process 230 includes the Filter Layer 232. The Filter Layer 232 generates a subset of page units by applying a filter, i.e., one or more filters, to the page units. Each filter is applied to the page units so unwanted page units will not be displayed on the Assembled Page 250. In one embodiment, a page unit can be filtered multiple times. In another embodiment, once a page unit has been filtered out by a first filter, it is possible that a second filter will not be applied to a filtered out page unit. In another embodiment, a page unit is filtered once.

The device-based filter was applied to page units to filter out page units that could not be properly displayed in a specific target device. For example, all the images that have a width larger than 600 pixels were filtered out by a device-based filter designed to be used with a Kindle® e-reader since that image cannot be displayed in the Kindle® screen without distortion.

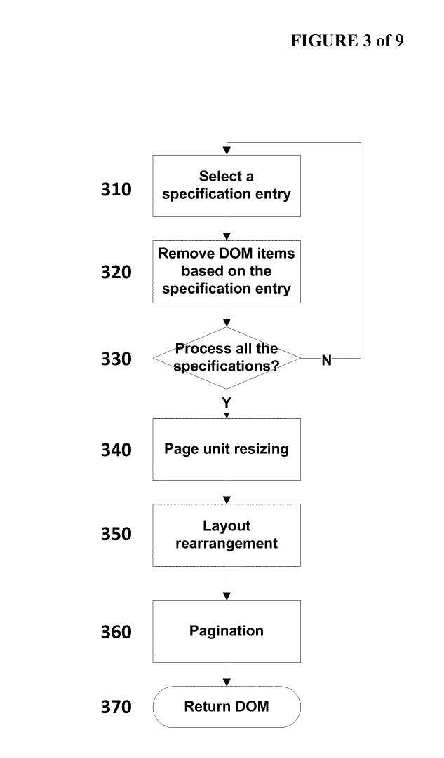

FIG. 3 illustrates an algorithm used in the device-based filter. In 310, the Filter Layer selects a device specification entry. A device specification provides detail about a specific kind of reading device, for example, but not limited to, screen height, screen width, and number of colors that the screen can render. Each specific entry can contain a pair of values: the attribute name and the attribute value. An example of such a specification for a reading device includes, but is not limited to:
SCREEN_WIDTH=600
SCREEN_HEIGHT=800
COLOR_TYPE=BW
NUMBER_OF_COLORS=16

With this device specification, the device-based filter can discard images in the DOM in which the width is greater than 600. Alternately, or in addition, the operation may change the width property of the image so that the whole image could fit into the screen specified for the device.

DOM items are then removed based on the device specification entry 320. The Filter Layer 232 then checks if all of the specification entries have been processed 330. If all of the specifications have not been processed, the Filter Layer 232 returns to step 310. If all of the specifications have been processed, the Filter Layer proceeds to the next phase of the algorithm whereby the page unit is properly formatted for assembly. The page unit is resized 340, its layout is rearranged 350 and paginated 360. The page unit is then returned 370.

The content-based filter was applied to page units to identify page units containing the patterns of advertisements to be filtered out. The content-based filter was also applied to filter page units containing Flash® and animated GIF images. The content-based filter was also applied to filter page units located in certain positions in the web page that would be difficult for the user to notice.

Content-based filtering using a geographic score takes into account the fact that users tend to pay more attention to those contents located in the “above the fold” and center of the screen. “Above the fold” refers to a location on a traditional printed newspaper as that area on the upper half of the front page of a newspaper. As a result, many web sites put the most relevant information within the above the fold and center area. Higher geographic scores are evaluated for DOM items within this area. For other parts of the web page, the relevance of the information tends to decrease as the content becomes further away from the focus center.

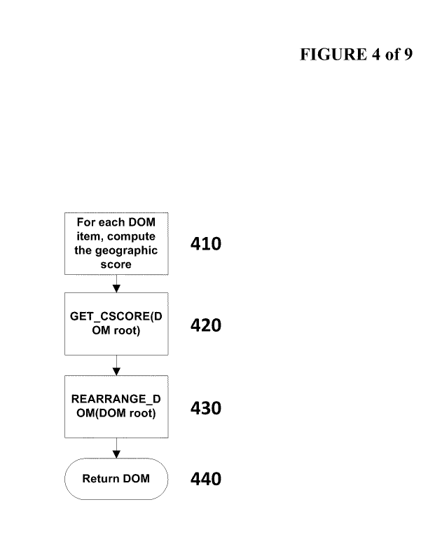

FIG. 4 illustrates an algorithm used in the content-based filter. In 410, a geographic score is computed for each DOM item. The geographic score is computed according to the following formula:

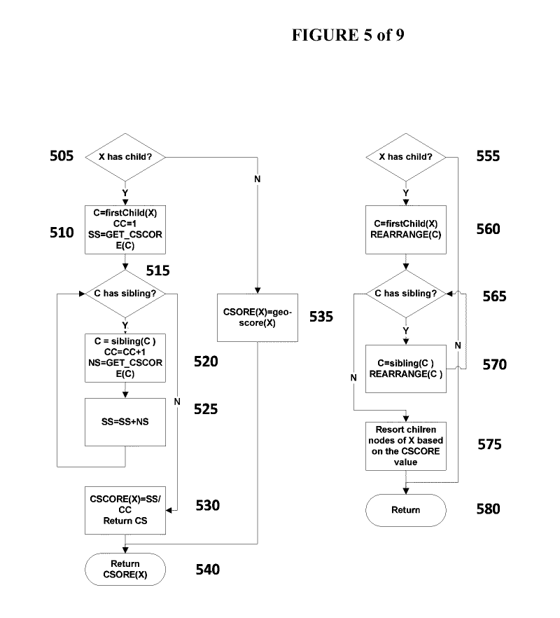

G=|w/2−x|*α−(y/h)*β

wherein w is screen width, h is screen height, x is the x coordinate of the item, y is the y coordinate of the item, α is horizontal relative factor, and β is vertical relative factor. The DOM item is then scored 420, rearranged 430, and returned 440. For each page unit, its geographic score is the summation of all the geographic scores of its children. FIG. 5 depicts recursive sub-algorithms to compute the geographic score for all the nodes in the DOM tree. For each node, a geographic score for each child of a DOM is computed and then the geographic scores for the children are summed 505-540 and returned 420.

Once the geographic score is evaluated, the DOM nodes are rearranged in a recursive fashion 555-580 and returned 430. The rearranging process begins at the root node for the DOM tree 555. For each DOM node, the children are sorted based on the descending order of the geographic score 575. The nodes of the children are rearranged and then each child node is visited recursively based on the same algorithm.

### Example 4

### Page Assembly Process

In accordance with a preferred embodiment of the present invention, a page assembly process will now be described with reference to FIGS. 1, 2, and 6-7. This process includes:
Function: Assemble subset of page units.
Input: Subset of page units.
Output: Assembled subset of page units.

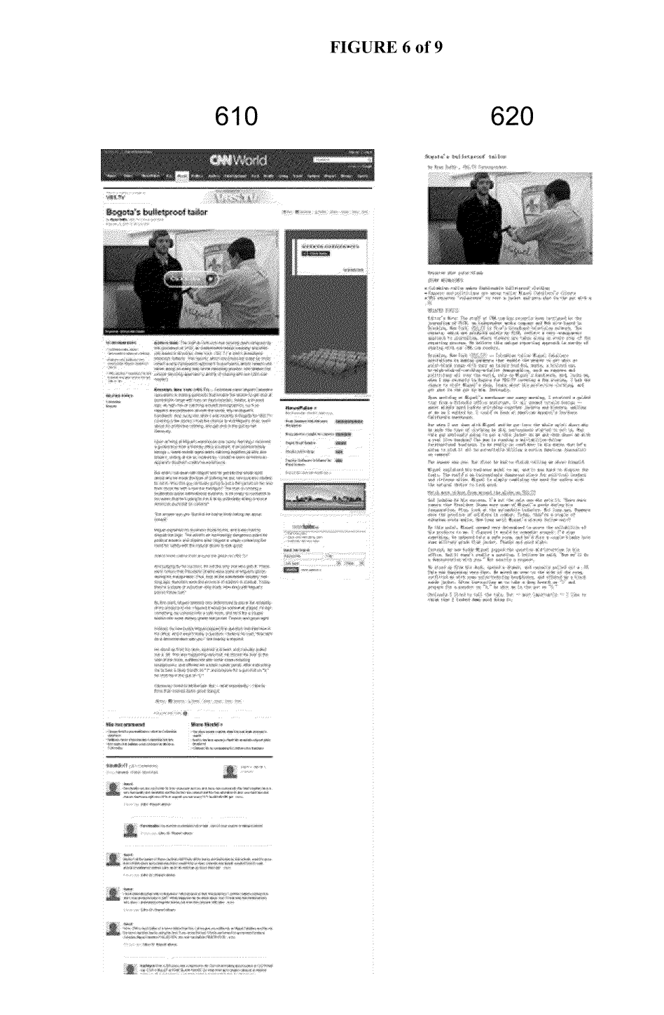

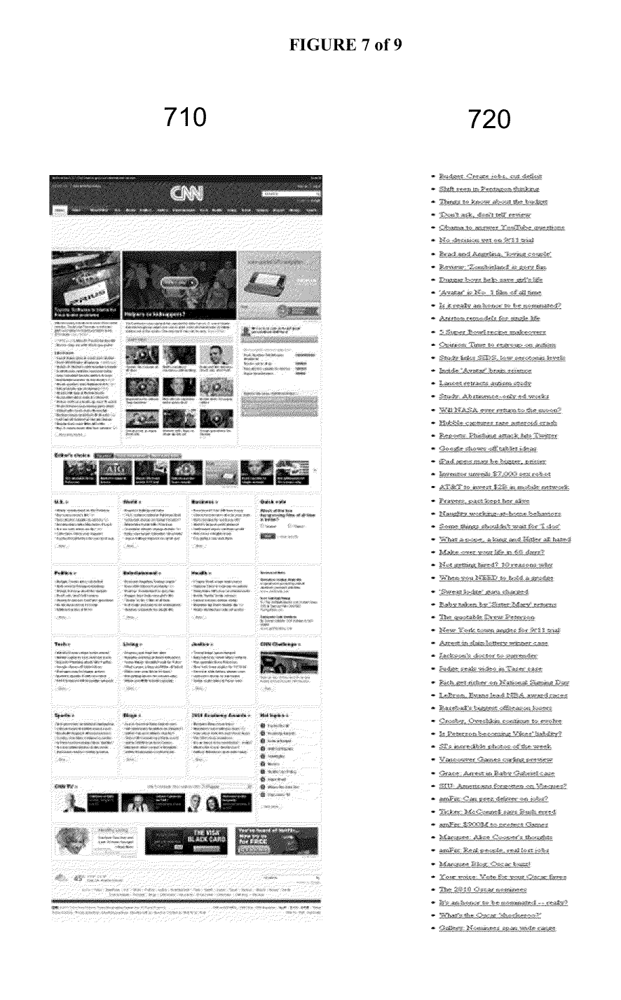

With reference to FIG. 2, the Assembly Process 240 includes the Assembly Layer 242 and the Rendering Layer 244. There are many standard file formats that can be used to transfer the subset of page units to a device to render the Assembled Page 250. XML format was used due to its simplicity. The page units were translated into XML files and then sent to a device. The device will parse the XML file and render the Assembled Page 250. An example of an Assembled Page includes a list of URLs, which represent a reading list, or a page which represents the essence of the Original Web Page 200. FIG. 6 illustrates the difference between a content based Original Web Page 610 and an embodiment of an Assembled Page 620. As is apparent in the Assembled Page 620, page units from the Original Web Page 610 were removed, such as, but not limited to, advertisements, header, footer, and comments. The page unit illustrated as a video in the Original Web Page 610 has been converted to an image in the Assembled Page 620. FIG. 7 illustrates the difference between an index based Original Web Page 710 and an embodiment of an Assembled Page 720. As is apparent in the Assembled Page 720, page units from the Original Web Page 710 were removed, such as, but not limited to, video, images, advertisements, header, and footer.

### Example 5

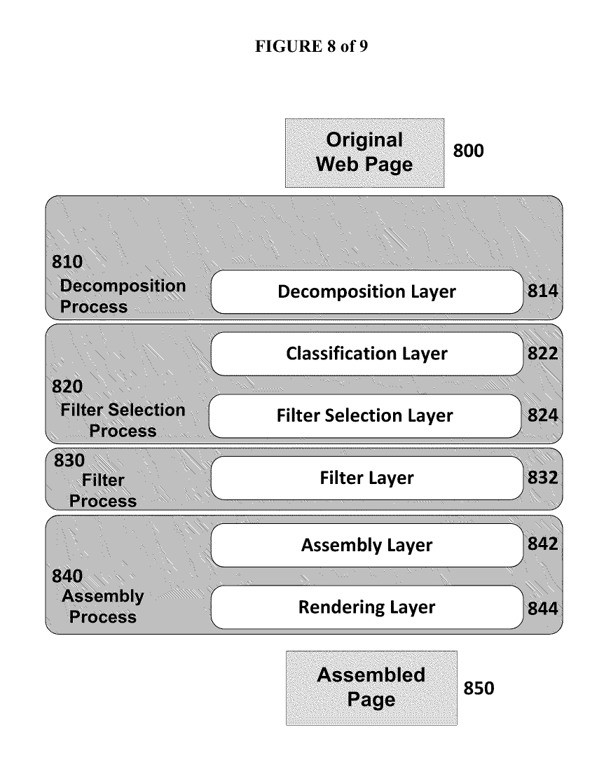

Example 5, as illustrated in FIG. 8, has six layers but does not include a Data Retrieval Layer 212. This embodiment of the present invention is slower than the embodiment illustrated in FIG. 2. Example 5 used multiple rendering engines in the Decomposition Layer 814 to analyze the Original Web Page 800. Without a Data Retrieval Layer 212 that stores the page locally, the Original Web Page will be downloaded multiple times and, thus, waste the network bandwidth and slow down the entire Decomposition Process 810.

### Example 6

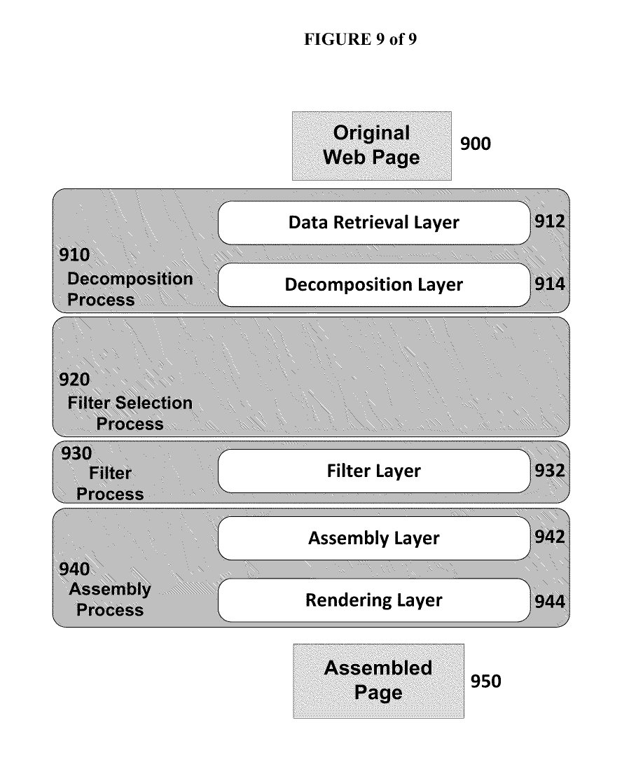

Example 6, as illustrated in FIG. 9, has five layers but does not include a Classification Layer 222 or a Filter Selection Layer 224. As a result, all filters used in the Filter Layer 932 of the Filter Process 930 are pre-selected. This implementation allows more unwanted page units in the Assembled Page. Generally, there are two different types of pages—an index page and a content page. An index page is a page with many useful URLs to access content. An example of an index page is www.cnn.com. A content page is a page that displays content such as news articles and stories.

The embodiment illustrated in FIG. 2, handles index pages and content pages differently. That embodiment preserves most of the URLs in the index page and presents the index page on a device in a similar way as the table of contents of a book. For a content page, the embodiment illustrated in FIG. 2 removes most of the URLs in the content page and presents the content page on a device in a similar way as the text of a book. Since Example 6 has pre-selected filters, the Assembled Page 950 either preserves URLs in both the index page and the content page or removes URLs in both the index page and the content page.

The foregoing description, including embodiments and examples, is for illustrative purposes and is not intended to limit the invention to the precise form disclosed. Persons skilled in the art are capable of appreciating other embodiments from the scope and spirit of the foregoing teaching.

We claim:

1. A method of displaying a web page on a mobile device comprising:
decomposing a web page into a plurality of page units;
applying a filter to at least one page unit and producing thereby a subset of the plurality of page units;
assembling the subset of page units;
displaying the assembled subset of page units as an assembled page.

2. The method of claim 1 further comprising storing the web page prior to decomposing the web page.

3. The method of claim 1 further comprising selecting a filter to apply to a page unit.

4. The method of claim 1 wherein the filter is pre-selected.

5. The method of claim 1 wherein the filter is a device-based filter.

6. The method of claim 1 wherein the filter is a content-based filter.

7. The method of claim 1 further comprising tagging at least one page unit with information about the location of that page unit in the web page.

8. The method of claim 7 wherein the information about the location of that page unit in the web page is used to determine the layout of the assembled page.

9. The method of claim 1 further comprising classifying the web page.

10. The method of claim 9 wherein the classification is associated with at least one filter.

11. The method of claim 1 further comprising classifying at least one page unit.

12. The method of claim 11 wherein the classification is associated with at least one filter.

13. The method of claim 1 wherein the mobile device is an electronic mobile reader.

14. A method of rendering a web page on a mobile device comprising:
decomposing a web page into a plurality of page units;
applying a filter to at least one page unit and producing thereby a subset of the plurality of page units;
assembling the subset of page units;
displaying the assembled subset of page units as an assembled page.

15. A mobile device capable of displaying an assembled page comprising:
a decomposer for decomposing a web page into a plurality of page units;
a filter for filtering at least one page unit and producing thereby a subset of the plurality of page units;
an assembler for assembling the subset of page units;
a display for displaying the assembled subset of page units as an assembled page.

16. A mobile device capable of displaying an assembled page comprising a display for displaying a subset of page units as an assembled page, wherein a plurality of page units are produced from a decomposed web page.

17. The mobile device of claim 16 further comprising an assembler for assembling the subset of page units.

18. The mobile device of claim 17 further comprising a filter for filtering at least one page unit and for producing thereby a subset of the plurality of page units.

19. The mobile device of claim 18 further comprising a decomposer for decomposing the web page into a plurality of page units.

20. The mobile device of claim 19 further comprising memory for storing the web page.

21. The mobile device of claim 18 further comprising a selection of filters to apply to at least one page unit.

22. The mobile device of claim 18 wherein the filter is pre-selected.

23. The mobile device of claim 18 wherein the filter is a device-based filter.

24. The mobile device of claim 18 wherein the filter is a content-based filter.

25. The mobile device of claim 19 wherein the at least one page unit further comprises a tag containing information about the location of that page unit in the web page.

26. The mobile device of claim 25 wherein the information about the location of that page unit in the web page is used to determine the layout of the assembled page.

27. The mobile device of claim 16 further comprising a classifier for classifying the web page.

28. The mobile device of claim 27 wherein the classification is associated with at least one filter.

29. The mobile device of claim 16 further comprising a classifier to classify at least one page unit.

30. The mobile device of claim 29 wherein the classification is associated with at least one filter.

31. A web server capable of communicating a web page to a mobile device comprising a decomposer for decomposing the web page into a plurality of page units and a transmitter to send at least one page unit to the mobile device.

32. The web server of claim 31 further comprising a filter for filtering at least one page unit and produce thereby a subset of the plurality of page units.

33. The web server of claim 32 further comprising an assembler for assembling the subset of page units.

34. The web server of claim 31 further comprising memory for storing the web page.

35. The web server of claim 32 further comprising a selection of filters to apply to at least one page unit.

36. The web server of claim 32 wherein the filter is pre-selected.

37. The web server of claim 32 wherein the filter is a device-based filter.

38. The web server of claim 32 wherein the filter is a content-based filter.

39. The web server of claim 31 wherein the at least one page unit further comprises a tag containing information about the location of that page unit in the web page.

40. The web server of claim 39 wherein the information about the location of that page unit in the web page is used to determine the layout of the assembled page.

41. The web server of claim 32 further comprising a classifier for classifying the web page.

42. The web server of claim 41 wherein the classification is associated with at least one filter.

43. The web server of claim 32 further comprising a classifier to classify at least one page unit.

44. The web server of claim 43 wherein the classification is associated with at least one filter.

45. A system for displaying an assembled page on a mobile device comprising:
a decomposer for decomposing a web page into a plurality of page units;
a filter for filtering at least one page unit and producing thereby a subset of the plurality of page units;
an assembler for assembling the subset of page units;
a display for displaying the assembled subset of page units as an assembled page.

46. The system of claim 45 further comprising memory for storing the web page prior to decomposing the web page.

47. The system of claim 45 further comprising a selection of filters to apply to at least one page unit.

48. The system of claim 45 wherein the filter is pre-selected.

49. The system of claim 45 wherein the filter is a device-based filter.

50. The system of claim 45 wherein the filter is a content-based filter.

51. The system of claim 45 wherein the at least one page unit further comprises a tag containing information about the location of that page unit in the web page.

52. The system of claim 51 wherein the information about the location of that page unit in the web page is used to determine the layout of the assembled page.

53. The system of claim 45 further comprising a classifier for classifying the web page.

54. The system of claim 53 wherein the classification is associated with at least one filter.

55. The system of claim 45 further comprising a classifier for classifying at least one page unit.

56. The system of claim 55 wherein the classification is associated with at least one filter.

57. The system of claim 45 wherein the mobile device is an electronic mobile reader.
